(19) United States
(12) Patent Application Publication
(10) Pub. No.: US 2010/0300186 A1
(43) Pub. Date: Dec. 2, 2010

(54) Pressure-Measuring Device

(76) Inventors: Christoph Kern, Aspach (DE); Ewgenij Landes, Remseck (DE); Michael Kleindl, Schwieberdingen (DE); Christian Doering, Stuttgart (DE); Steffen Schott, Schwieberdingen (DE); Pavlo Saltikov, Waiblingen (DE)

Correspondence Address: KENYON & KENYON LLP, ONE BROADWAY, NEW YORK, NY, 10004, US

(21) Appl. No.: 12/308,536

(22) PCT Filed: Aug. 16, 2007
(86) PCT No.: PCT/EP2007/058496

§ 371 Date: Aug. 11, 2010

(30) Foreign Application Priority Data
Oct. 13, 2006 (DE) 102006049079.7

(51) Int. Cl. G01M 15/08

(52) U.S. Cl. 73/114.19

(57) ABSTRACT

A pressure-measuring device is to be placed in a chamber of an internal combustion engine. The pressure-measuring device has a housing, a force-transmission element projecting out of the housing, and a pressure sensor disposed in an interior chamber of the housing. On the one hand, the pressure sensor is braced on a fixation element. On the other hand, to detect a pressure prevailing inside the chamber, the pressure sensor is operatively connected to the force-transmission element. The pressure sensor has a straight-through recess through which an electrical line is routed. In addition, a positioning element is provided, which has a straight-through recess in a guide region, the electrical line being routed through the straight-through recess, and the positioning element having a reduced thickness in the guide region. This makes it possible to reduce friction of the electrical line in the guide region at the straight-through recess, so that the pressure measurement is improved.

### FIELD OF THE INVENTION

The present invention relates to a pressure-measuring device to be situated in a chamber of an internal combustion engine. More specifically, the present invention relates to a pressure-measuring glow plug to be situated in a prechamber, a whirl chamber or a combustion chamber of an air compressing, self-igniting internal combustion engine.

### BACKGROUND INFORMATION

A pressure-measuring glow plug for a Diesel engine is described in German Patent Application No. DE 103 43 521 A1. The conventional pressure-measuring glow plug has a plug body to be inserted into a cylinder of the Diesel engine. In addition, the conventional pressure-measuring glow plug has a heating rod disposed inside the plug body, and a sensor system. The sensor system is prestressed between the plug body and a contact conduit which is connected to the heating rod, and a clamping element is provided, which is screw-fitted with the contact conduit. On the one side, the sensor system rests against the clamping element, and on the other side it rests against the plug body. The sensor system is used to measure a pressure inside the combustion chamber of the cylinder, which is transmitted via the heating rod and the contact conduit. The electrical connection of the pressure-measuring glow plug is implemented via a connection terminal and an inner pole; the connection terminal may be in the form of a thread or a plug-in connection.

One of the disadvantages of the pressure-measuring glow plug described in German Patent Application No. DE 103 43 521 A1 is that a multitude of individual parts must be mutually adjusted, assembled and positioned during installation of the pressure-measuring glow plug. Thus, the installation is relatively labor-intensive. For another, there is the disadvantage that the sensor system is situated at a relatively great distance at the end of the pressure-measuring glow plug facing away from the chamber, the installation is complex, and force shunts produced by friction losses or the like have an adverse effect on the pressure measurement by the sensor system.

International Patent Application No. WO 2006/089446 A1 describes a glow plug having a subassembly for piezoelectric pressure sensors is known. This subassembly has a transmission body having a pin, the pin including a central guideway for routing a glow current wire, and guideways for lines, so that the lines are thermally and electrically insulated from the glow current wire. Furthermore, an electrically insulating film is provided, which surrounds a plurality of components of the subassembly on the outside and mechanically keeps them together.

The glow plug described in International Patent Application No. WO 2006/089446 A1 has the disadvantage that a relatively large hysteresis occurs when a varying pressure is measured, which worsens the precision of the pressure measurement.

### SUMMARY

An example pressure-measuring device according to the present invention may have the advantage that the installation of the pressure-measuring glow plug is simplified and an improved accuracy is able to be achieved in the pressure measurement.

It may be advantageous if the positioning element has atleast one constriction in the region of the straight-through recess. Because of the constriction in the straight-through recess the positioning element has reduced thickness in the guide region, so that an area of friction between the electrical line, in particular a glow current line, and the straight-through recess in the guide region is reduced. This reduces friction losses which may lead to a hysteresis in the pressure acquisition.

It may be advantageous if the positioning element has a conical guide section in the region of the straight-through recess. It is also possible to provide two conical guide sections, which are situated on both sides of the straight-through recess of the positioning element. Because of the conical guide sections, a construction that causes reduced friction between the electrical line and the straight-through recess may be formed, for one. For another, the conical guide section is able to facilitate the installation since the electrical line may be threaded through, so to speak, with regard to the constriction.

The electrical line is able to be connected to the force transmission element or an additional element connected to the force transmission element. For example, a glow current line may be connected to a heating element employed as force transmission element. If the force generated by the pressure in the chamber is transmitted via the heating element, then the glow current line may offer a certain resistance to this movement. To reduce this resistance, it may be advantageous if the electrical line (7) has at least one coiled filament section (29), which, in relation to the positioning element (20), is disposed on the side of the power-transmission element (6). The coiled filament section allows a certain flexibility of the electrical line in order to accommodate movements of the force-transmission element. Furthermore, the mentioned placement of the coiled filament section reduces movements of the electrical line in the region of the guide section, so that the occurring frictional forces are reduced as well. This provides a further improvement of the pressure measurement.

It may be advantageous if a pressure-measuring module is provided, which includes the pressure sensor and the positioning element, and if the pressure sensor is supported at the fixation element with the aid of the positioning element. This results in a compact design of the pressure-measuring device, and the positioning of the electrical line is ensured by the installation of the pressure-measuring module, so that the installation of the pressure-measuring device is facilitated.

The positioning element advantageously includes a circumferential collar in an outer force-transmission element. The positioning element preferably has reduced thickness in a center region. This ensures relatively high stability of the positioning element in a region in which relatively high forces are acting on the positioning element, while the thickness in the center region is selected such that the usually radially acting forces for the positioning of the electrical line are absorbed in a reliable manner.

The positioning element advantageously has additional straight-through recesses, which are used to feed measuring lines through the positioning element. The measuring lines are therefore able to be routed from a chamber-remote end of the pressure-measuring device to a pressure sensor which is positioned in relatively close proximity to the force-transmission element. It is advantageous if the positioning element includes a generally centered, preferably cylindrical recess. This construction may also form a collar in the outer region of the positioning element. The cylindrical recess enables the engagement with an installation tool. An installation aid may be provided, which has a sleeve-type design and encloses the positioning element as well as additional elements of the pressure-measuring module, in particular the pressure sensor. The installation tool engaging with the cylindrical recess may be used to insert the pressure-measuring module into the housing of the pressure-measuring glow plug. A certain prestressing of the pressure-measuring module is possible following its insertion. The installation aid may then be removed in the prestressed state, centering of the elements of the pressure-measuring module being ensured. Then, the fixation element may be installed and connected to a sensor cage or the like, for example by welding. This connection then ensures the prestressing of the elements of the pressure module, so that the installation tool engaging with the cylindrical recess is able to be removed. Thus, the installation of the pressure-measuring device is able to be simplified, and a prefitting of the pressure-measuring module in the form of a preassembly will not be required.

The positioning element is advantageously designed as a generally disk-shaped positioning element, and the straight-through recess may be formed as a through hole. This has the advantage of allowing a cost-effective production of the positioning element. Relatively high pressure stability results in addition.

The positioning element is preferably made of an aluminum oxide, especially Al₂O₃, it also being possible to admix additives to the aluminum oxide. High purity of the aluminum oxide is especially advantageous in order to ensure high electrical insulation resistance. For example, a purity of at least 96%, especially at least 99%, is advantageous.

### BRIEF DESCRIPTION OF THE DRAWINGS

A preferred exemplary embodiment of the present invention is explained in greater detail below with reference to the figures in which identical elements have been provided with matching reference numerals.

FIG. 1 shows a schematic sectional view of an exemplary embodiment of a pressure-measuring device according to the present invention.

FIG. 2 shows a section through the pressure-measuring device shown in FIG. 1 along the sectional line denoted by II.

### DETAILED DESCRIPTION OF EXAMPLE EMBODIMENTS

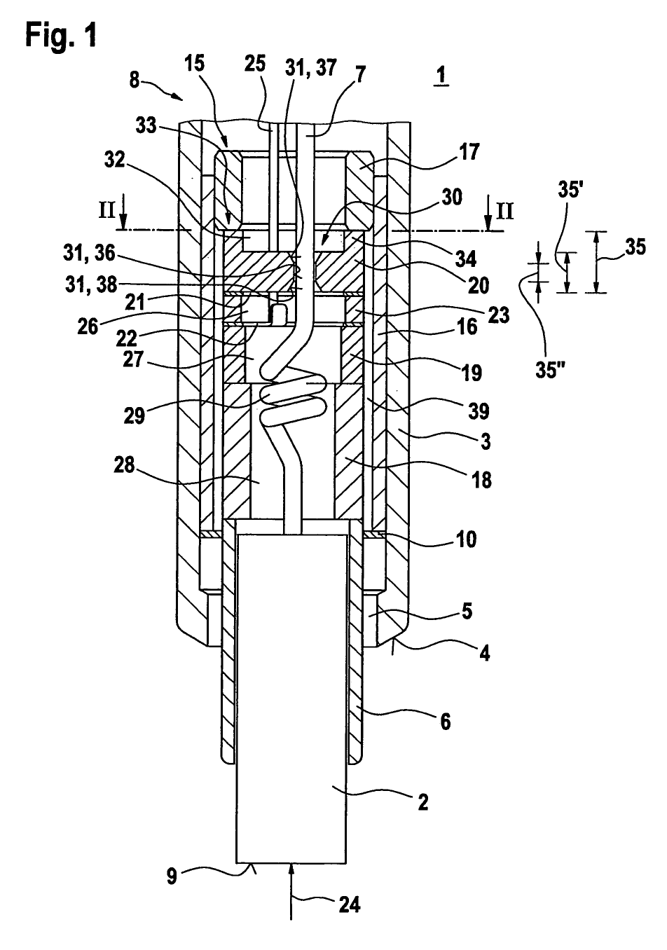

FIG. 1 shows a first exemplary embodiment of a pressure-measuring device 1 in an axial sectional representation. Pressure-measuring device 1 is developed as pressure-measuring glow plug 1 for an air-compressing, self-igniting internal combustion engine. A rod-shaped heating element 2 of pressure-measuring glow plug 1 projects into the chamber of the internal combustion engine in the case of pre-chamber and whirl chamber engines and, in the case of engines having direct injection, into a combustion chamber of the engine. However, pressure-measuring glow plug 1 of the present invention is also suitable for other applications. For instance, pressure-measuring device 1 may be designed as pressure-measuring glow plug for mixture-compressing internal combustion engines having externally supplied ignition.

Pressure-measuring glow plug 1 has a housing 3 with a sealing cone 4. Rod-shaped heating element 2 partially projects from housing 3 through an opening 5 on the side of the chamber. Furthermore, a force-transmission element 6 is provided, which is connected to rod-shaped heating element 2 and encloses it sectionally. Force-transmission element 6 partially projects out of housing 3 through chamber-side opening 5. Rod-shaped heating element 2 is connected to an electrical line 7 realized as glow current line 7. Glow-current line 7 extends from a chamber-remote end 8 of housing 3 through an interior chamber of housing 3 to rod-shaped heating element 2.

Rod-shaped heating element 2 has a glow tip 9, which projects beyond force-transmission element 6. Force-transmission element 6 is connected to a sensor cage 16 via a metal diaphragm 10 shown in simplified form. Metal diaphragm 10 has an elastic design in order to reduce a force shunt between force-transmission element 6 and housing 3 via sensor cage 16. Sensor cage 16 is part of a pressure-measuring module 15, which is disposed in the interior of housing 3. Furthermore, sensor cage 16 includes a fixation element 17 joined to sensor cage 16 by, for example, a welding seam, a spacer 18 resting against force-transmission element 6, a rigid compensating element 19 resting against spacer 18, a positioning element 20 being braced on fixation element 17, contact plates 21, 22, as well as a pressure sensor 23 disposed between contact plates 21, 22. Pressure sensor 23 is braced at fixation element 17 by way of positioning element 20. In addition, pressure sensor 23 is operatively linked to force-transmission element 6 via rigid compensating element 19 and spacer 18.

Pressure sensor 23 is disposed inside housing 3 in such a way that a reliable protection of pressure sensor 23 is ensured. On the one hand, pressure sensor 23 is braced via positioning element 20 on fixation element 17. On the other hand, pressure sensor 23 is operatively linked to force-transmission element 6 via rigid compensating element 19 and spacer 18 in order to detect a pressure prevailing inside the chamber. The pressure inside the chamber generates a force 24 acting on glow tip 9, which is transmitted to force-transmission element 6 via rod-shaped heating element 2. A corresponding force on pressure sensor 23 results as a function of the magnitude of force 24.

Contact plates 21, 22 are connected to electrical measuring lines 25, via which a measuring charge produced in the action on pressure sensor 23 is able to be transmitted to a suitable evaluation circuit. Pressure sensor 23 may be made of a piezoelectric material, for example. Pressure sensor 23 has a straight-through recess 26, which allows measuring lines 25 to be connected to contact plates 21, 22. Furthermore, straight-through recess 26 makes it possible to thread glow-current line 7 through pressure sensor 23. In addition, rigid compensating element 19 is provided with a straight-through recess 27. Spacer 18 likewise has a straight-through recess 28. Both spacer 18 and rigid compensating element have a sleeve-type design. Via recess 27 of rigid compensating element 19 and recess 28 of spacer 18, glow-current line 7 is routed from chamber-remote end 8 of housing 3 through rigid compensating element 19 and spacer 18 to rod-shaped heating element 2. The sleeve-type design of compensating element 19 and spacer 18 makes it possible to dispose a coiled filament section 29 of glow-current line 7 between positioning element 20 and rod-shaped heating element 2. Glow-current line 7 may have one or several coils in coiled filament section 29, approximately one to approximately three coils being particularly advantageous. Coiled filament section 29 ensures a certain elasticity of glow-current line 7, so that mechanical resistance of glow-current line 7 with respect to shifts in adjustment of rod-shaped heating element 2 and thus of force-transmission element 6 are reduced.

Positioning element 20 has a straight-through recess 31 in a guide region 30, through which glow-current line 7 is guided from chamber-remote end 8 to rod-shaped heating element 2. Guide section 30 ensures radial positioning of glow-current line 7 inside housing 3, thereby providing relatively high vibration resistance. Furthermore, positioning element 30 is made of an electrically insulating material, e.g., an aluminum oxide, so that a short circuit between glow-current line 7 and housing 3 is prevented. The positioning of glow-current line 7 with the aid of positioning element 20 prevents contact between glow-current line 7 and additional elements of pressure-measuring glow plug 1, especially pressure-measuring module 15, which may be designed to be electrically conductive. However, additional elements for the fixation of glow-current line 7 may be provided in the region of chamber-remote end 8, which in this case are likewise designed to be electrically insulating.

Positioning element 20 has a cylindrical recess 32, which allows an advantageous installation of the positioning element together with pressure sensor 23, rigid compensating element 19, and spacer 18. For this purpose an installation tool may engage with the cylindrical recess 32 of positioning element 20; positioning element 20, pressure sensor 23 with contact plates 21, 22, compensating element 19, and spacer 18 are enclosed by a sleeve-type installation aid. The sleeve-type installation aid ensures relative positioning of the individual parts. Prestressing of pressure sensor 23 following installation in housing 3 may be achieved with the aid of the installation tool. The sleeve-type installation aid is then removed so that sleeve-type air gap 39 remains within sensor cage 16. Next, a fixation with the aid of fixation element 17 takes place, which is joined to sensor cage 16 by welding, for example. The installation aid engaging with cylindrical recess 32 may then be removed. Annular gap 39 thus prevents contact with sensor cage 16. An installation foil, an electrically insulating foil or the like that remains in housing 3 and via which partial contact with sensor cage 16 may occur, is not required. Frictional losses, in particular, which arise in a partial contact of a foil with sensor cage 16 are prevented. Cylindrical recess 32 is preferably designed in such a way that sufficient stability of positioning element 20 in an outer force-transmission region 33 is ensured in order to transmit the forces that occur in the pressure measurement to fixation element 17. In particular the remaining collar 34 of positioning element 20 in outer force-transmission region 33 is designed to allow bracing at fixation element 17 across a relatively large surface. In addition, on account of cylindrical recess 32, a thickness 35′ in guide region 30 is reduced in comparison with thickness 35 exhibited by the positioning element in the region of collar 34. Furthermore, positioning element 20 has a constriction 36, which is formed between a conical guide section 37 and a conical guide section 38 of straight-through recess 31. As a result, positioning element 20 has an even further reduced thickness 35″ in the region of constriction 36. Conical guide sections 37, 38 are provided on both sides of positioning element 20. Due to conical guide sections 37, 38, the installation of positioning element 20 is facilitated in addition, since glow-current line 7 is able to be fed through straight-through recess 31 more easily.

During operation of pressure-measuring device 1, the contact area between glow-current line 7 and straight-through recess 31 is usually restricted by the size of constriction 36. In the borderline case, restriction 36 may specify a nearly linear contact area. However, the size of thickness 35″ of positioning element 20 in the region of constriction 36 of straight-through recess 31 in guide section 30 is selected such that sufficient mechanical stability for the reliable positioning of glow-current line 7 is ensured.

As a result, to reduce the contact area between glow-current line 7 and positioning element 20, which may be in the form of a centering disk, thickness 35″ of positioning element 20 in guide region 30 is reduced to such an extent that a durable component design is still ensured. This minimizes the friction of glow current line 7 in guide region 30, so that virtually hysteresis-free guidance is achieved. The form and dimensions of straight-through recess 31 may be selected such that the cross section of straight-through recess 31 is no larger than required for the line feedthrough of glow-current line 7. This not only contributes to higher component stability but also restricts the amplitude of lateral oscillations of glow-current line 7, so that the resistance to vibrations of glow-current line 7 is increased. The installation is ensured by conical guide section 38, in particular.

Straight-through recess 31 is preferably formed by a through hole beveled on both sides. However, other designs of straight-through recess 31 are conceivable as well. In particular, guide sections 37, 38 may also have a rounded or similar design. Furthermore, positioning element 20 is preferably at least essentially disk-shaped. This further reduces the overall length of pressure-measuring module 15. In addition, the length of spacer 18 is optimized to the effect that coiled filament section 29 is able to be disposed between pressure sensor 23 and rod-shaped heating element 2.

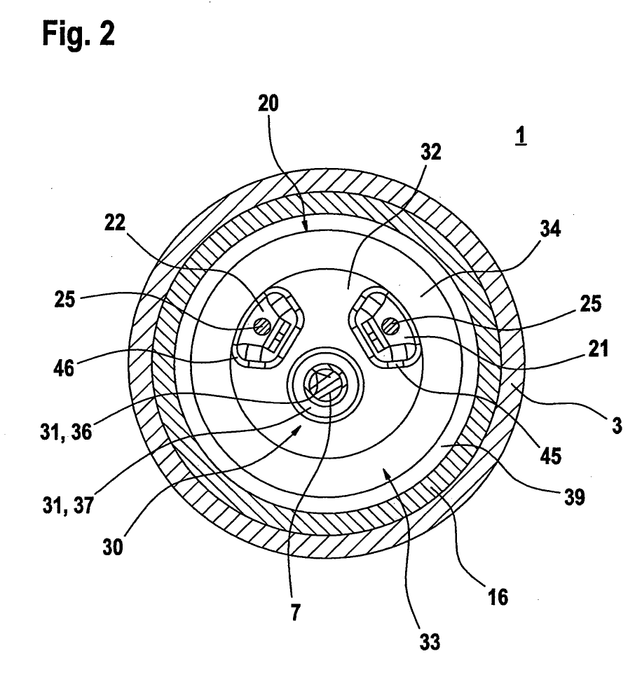

FIG. 2 shows a section through pressure-measuring device 1 shown in a sectional view in FIG. 1, along the sectional line denoted by II. Positioning element 20 has additional straight-through recesses 45, 46 through which electrical measuring lines 25 are routed from chamber-remote end 8 of housing 3 to contact plates 21, 22. Straight-through recesses 45, 46 provide a certain anti-rotation protection for electrical measuring lines 25. The remaining material of positioning element 20 between straight-through recesses 31, 34, 46 is selected to be of large enough size to ensure sufficient stability of positioning element 20. It is also possible, as illustrated in

FIG. 2, to slightly shift the position of straight-through recess 31 of positioning element 20 used for the feedthrough of glow-current line 7 from a centered position. Glow-current line 7 then is essentially routed through housing 3 in coaxial fashion.

One advantage of the described design is that the length of the force path in the pressure-measuring module is shortened. As a result, pressure sensor 23 may be situated in relatively close proximity to sealing cone 4 where a relatively low temperature prevails by the contact with the internal combustion engine.

Furthermore, natural frequencies of the pressure-measuring module are increased, so that the signal frequency of the measuring signal is improved.

The present invention is not restricted to the described exemplary embodiment. Positioning element 20, in particular, may also have a disk-shaped design, in which case cylindrical recess 32 is omitted.

1-11. (canceled)

12. A pressure-measuring device to be situated in a chamber of an internal combustion engine, comprising:
a housing;
a force-transmission element which at least partially projects from the housing;
a pressure sensor disposed in an interior chamber of the housing, the pressure sensor being braced at least indirectly on a fixation element, and being at least indirectly operatively connected to the force-transmission element to detect a pressure prevailing inside the chamber, and the pressure sensor having a straight-through recess through which an electrical line is routed; and
a positioning element having a straight-through recess in a guide region, the electrical line being routed through the straight-through recess, and the positioning element having a reduced thickness at least in the guide region.

13. The pressure-measuring device as recited in claim 12, wherein the pressure-measuring device is a pressure-measuring glow plug for an air-compressing, self-igniting internal combustion engine.

14. The pressure-measuring device as recited in claim 12, wherein the positioning element has at least one constriction in a region of the straight-through recess.

15. The pressure-measuring device as recited in claim 12, wherein the positioning element has at least one conical guide section in a region of the straight-through recess.

16. The pressure-measuring device as recited in claim 12, wherein the electrical line has at least one coiled filament section, which, in relation to the positioning element, is disposed on a side of the force-transmission element.

17. The pressure-measuring device as recited in claim 12, wherein a pressure-measuring module is provided, which includes the pressure sensor and the positioning element, and the pressure sensor is braced on the fixation element using the positioning element.

18. The pressure-measuring device as recited in claim 17, wherein the positioning element has a circumferential collar in an outer force-transmission region.

19. The pressure-measuring device as recited in claim 17, wherein the positioning element has at least one additional straight-through recess, and at least one measuring line is routed through the additional straight-through recess from a chamber-remote end to the pressure sensor.

20. The pressure-measuring device as recited in claim 12, wherein the positioning element has at least one centered, cylindrical recess.

21. The pressure-measuring device as recited in claim 12, wherein the positioning element is at least generally designed as disk-shaped positioning element.

22. The pressure-measuring device as recited in claim 12, wherein the straight-through recess of the positioning element is designed as a through-hole.

23. The pressure-measuring device as recited in claim 12, wherein the positioning element is formed by at least one aluminum oxide.
